(19) United States
(12) Patent Application Publication
(10) Pub. No.: US 2016/0071680 A1
(43) Pub. Date: Mar. 10, 2016

(54) PROTECTIVE ELEMENT

(71) Applicant: DEXERIALS CORPORATION, Tokyo (JP)

(72) Inventors: Koichi MUKAI, Utsunomiya-shi (JP); Kanna MIYAZAKI, Utsunomiya-shi (JP)

(21) Appl. No.: 14/888,337

(22) PCT Filed: May 1, 2014
(86) PCT No.: PCT/JP2014/062076

§ 371 Date: Oct. 30, 2015

(30) Foreign Application Priority Data
May 2, 2013 (JP) 2013-096753

(51) Int. Cl. H01H 85/08; H01H 85/00

(52) U.S. Cl. CPC H01H 85/08; H01H 85/0047

(57) ABSTRACT

A protective element achieves oxide film removing functionality in a flux enabling quick melting of a meltable conductor even when the heating temperature of a heating element is raised rapidly. Protective element includes an insulating substrate, heat-generating resistor laminated onto the insulating substrate, insulating member covering the heat-generating resistor, first and second electrode laminated onto the insulating substrate, heat-generating element extracting electrode laminated onto the insulating member so as to overlap the heat-generating element and electrically connected to the heat-generating element on a current path between the first and second electrodes, meltable conductor which is laminated above the heat-generating element extracting electrode between the first and second electrode which interrupts the current path between the first and second electrode by melting due to heat, and oxide film removing material for removing oxide film generated on the meltable conductor, the oxide film removing material having a plurality of different activation temperatures.

### TECHNICAL FIELD

The present invention relates to a protective element which interrupts a current path when an abnormality such as over-charging or over-discharging occurs. This application claims priority to Japanese Patent Application No. 2013-096753 filed on May 2, 2013, the entire content of which is hereby incorporated by reference.

### BACKGROUND ART

Secondary batteries are often provided to users in the form of rechargeable battery packs which can be repeatedly used. In particular, in order to protect users and electronic appliances, lithium ion secondary batteries having a high volumetric energy density typically include several protective circuits incorporated in battery packs for over-charging protection and over-discharging protection to interrupt the output of the battery pack under predetermined conditions.

Some of these protective elements use an FET switch incorporated in a battery pack to turn ON/OFF the output, for over-charging protection or over-discharging protection of the battery pack. However, even in the cases of the FET switch being short-circuited and damaged for some reason, a large current caused by a surge such as lighting momentarily flowing, or an abnormally decreased output voltage or an excessively high output voltage occurring in an aged battery cell, the battery pack or the electronic appliance should prevent accidents including fire, among others. For this reason, a protective element is used having a fuse element which interrupts a current path in accordance with an external signal so as to safely interrupt the output of the battery cell under these possible abnormalities.

As shown in FIG. 10 (A) and FIG. 10 (B), in a protective element 80 of a protective circuit for such lithium ion secondary batteries, a meltable conductor 83 is connected between a first and second electrodes 81, 82 as a part of a current path and the meltable conductor 83 on the current path is blown by self-heating caused by an overcurrent or by a heat-generating element 84 provided within the protective element 80. In such a protective element 80, the molten meltable conductor 83, now in a liquid form, gathers on the first and second electrode 81, 82 to interrupt the current path.

### PRIOR ART LITERATURE

### Patent Literatures

PLT 1: Japanese Unexamined Patent Application Publication No. 2010-003665

PLT 2: Japanese Unexamined Patent Application Publication No. 2004-185960

PLT 3: Japanese Unexamined Patent Application Publication No. 2012-003878

### SUMMARY OF THE INVENTION

### Problem to be Solved by the Invention

In such a protective element 80 as illustrated in FIG. 10, in general, a Pb-containing high melting point solder having a melting point of 300° C. or more is used as the meltable conductor 83 so that melting does not occur during mounting by reflow solder bonding. Furthermore, because heating the meltable conductor 83 promotes oxidation which inhibits blowout, a flux 85 is laminated thereon in order to remove oxide film generated on the meltable conductor 83.

Because, for example, thermal runaway in a secondary lithium ion battery might cause a serious accident, it is desirable that the meltable conductor in this variety of protective element blowout as quickly as possible. For this reason, applying a large amount of electrical power to a heat-generating element within the protective element as a method for rapidly increasing temperature can be considered.

However, in the case of rapidly raising the temperature of the meltable conductor by heating with the heat-generating element, oxidation proceeds more quickly and either the oxide film removing functionality of the flux is not fully exhibited or overheating of the flux deactivates the oxide film removing functionality of the flux, and blowout time is lengthened, which might lead to an adverse cycle in which rising temperature caused by further heating continues.

Additionally, an activation temperature range in which the flux exhibits oxide film removing functionality is determined by an additive activation agent and, in the case of a target application of removing oxide film at the time of reflow solder bonding, is from 100° C. to 260° C.

However, because the heating temperature of the heat-generating element of the protective element reaches a temperature of a few hundred degrees in a moment (less than one second), a large difference between the activation temperature range of the flux and the heating temperature is generated and oxide film removing functionality is not sufficiently exhibited. Furthermore, electrical output conditions vary among electronic appliances incorporating the protective element and the heating temperature of the heat-generating element changes depending on the amount of electrical power applied. Because of this, multiple varieties of protective elements must be provided having flux with different activation temperatures depending on the target electronic device, which complicates manufacturing processes and might increase manufacturing costs.

Furthermore, even in the same electronic appliance, because, for example, the number of lithium ion secondary batteries incorporated, the charge/discharge status thereof and/or the degradation status thereof change, the electrical power applied to the heat-generating element of the protective element also changes. Therefore, it might not be possible to make a flux having a fixed activation temperature range compatible with an electrical output status of a targeted electronic appliance.

For this reason, an object of the present invention is to provide a protective element in which a flux can fully exhibit oxide film removing functionality even in the cases of a heating temperature of a heat-generating element rising rapidly or slowly and under a variety of heating conditions, and which can enable rapid blowout of a meltable conductor.

### Solution to Problem

In order to solve the aforementioned problem, a protective element according to the present invention comprises an insulating substrate; a heat-generating element laminated onto the insulating substrate; an insulating member laminated onto the insulating substrate covering at least the heat-generating element; a first and a second electrode laminated onto the insulating substrate having the insulating member laminated thereon; a heat-generating element extracting electrode laminated on the insulating member overlapping the heat-generating element and electrically connected to the heat-generating element on a current path between the first and the second electrode; a meltable conductor laminated between the heat-generating element extracting electrode and the first and the second electrode and which interrupts the current path between the first and the second electrode by melting due to heat; and an oxide film removing material for removing an oxide film generated on the meltable conductor; wherein the oxide film removing material has a plurality of different activation temperatures.

### Advantageous Effects of Invention

The present invention can achieve compatibility with a variety of temperature profiles without dependence on the type of electronic appliance or changes in the electric power status thereof so that oxidation of the meltable conductor can be prevented and a current path can be reliably interrupted.

### BRIEF DESCRIPTION OF DRAWINGS

FIG. 1 illustrates a protective element according to the present invention in (A) a perspective view and (B) a cross-sectional view.

FIG. 2 is a plan view illustrating a protective element according to the present invention.

FIG. 3 is a graph illustrating a relation between activation temperatures and activation temperature ranges of flux according to the present invention and heating profiles.

FIG. 4 is a circuit diagram illustrating a circuit configuration of a battery pack.

FIG. 5 is a diagram illustrating an equivalent circuit of a protective element according to the present invention.

FIG. 6 illustrates another protective element according to the present invention in (A) a perspective view and (B) a cross-sectional view.

FIG. 7 illustrates another protective element according to the present invention in (A) a perspective view and (B) a cross-sectional view.

FIG. 8 illustrates another protective element according to the present invention in (A) a perspective view and (B) a cross-sectional view.

FIG. 9 is a graph illustrating a relationship between applied electrical power and blowout time of (A) an example and (B) a comparative example.

FIG. 10 illustrates a conventional protective element in (A) a perspective view and (B) a cross-sectional view.

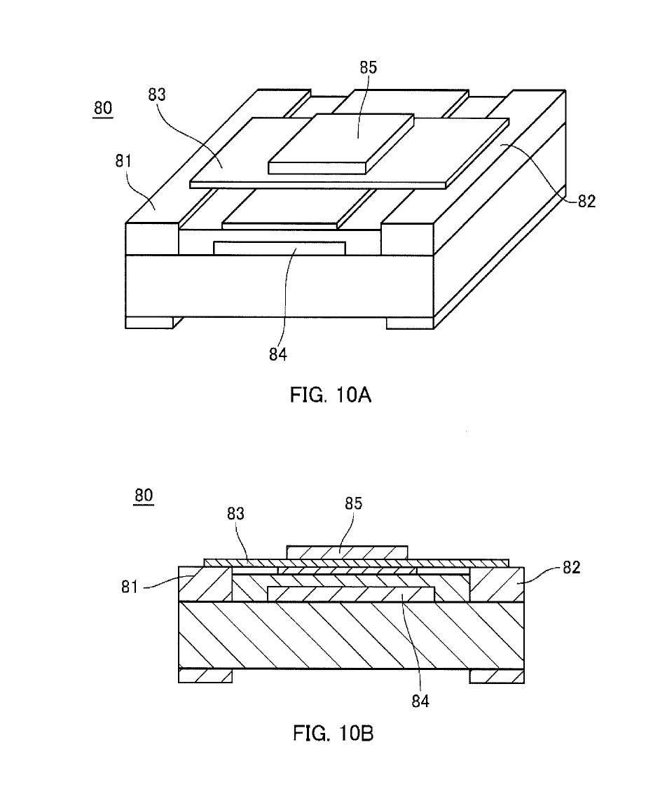

### DESCRIPTION OF EMBODIMENTS

Embodiments of the protective element according to the present invention will now be more particularly described with reference to the accompanying drawings. It should be noted that the present invention is not limited to the embodiments described below and various modifications can be added to the embodiment without departing from the scope of the present invention. The features shown in the drawings are illustrated schematically and are not intended to be drawn to scale. Actual dimensions should be determined in consideration of the following description. Moreover, those skilled in the art will appreciate that dimensional relations and proportions may be different among the drawings in some parts.

Protective Element Structure

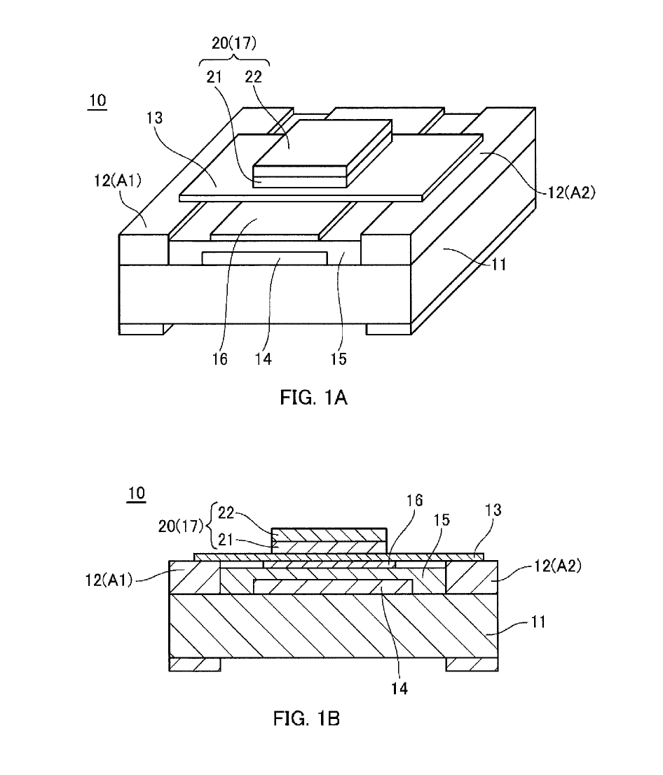

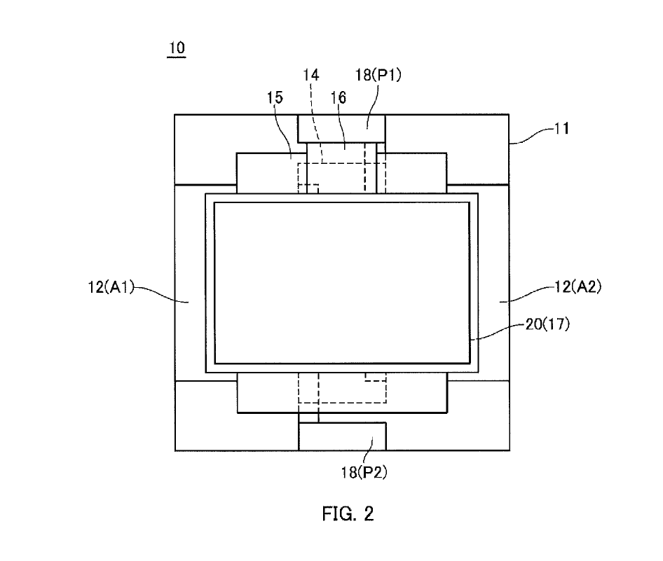

As illustrated in FIGS. 1 (A) and (B) and FIG. 2, a protective element 10 according to the present invention includes an insulating substrate 11, a heat-generating resistor 14 laminated on the insulating substrate 11 and covered by an insulating member 15, electrodes 12 (A1), 12 (A2) provided on both edges of the insulating substrate 11, a heat-generating element extracting electrode 16 laminated on the insulating member 15 overlapping the heat-generating resistor 14, a meltable conductor 13 connected on both ends to the electrodes 12 (A1), 12 (A2), respectively, and connected at a central portion to the heat-generating element extracting electrode 16, and an oxide film removing agent 17 provided on the meltable conductor 13 for removing oxide film generated on the meltable conductor 13.

The insulating substrate 11 may be formed in a rectangular shape from insulating materials including alumina, glass ceramics, mullite and zirconia, among others. Other materials used for printed circuit boards such as glass epoxy substrate or phenol substrate may be used as the insulating substrate 11; however, consideration of the temperature at the time of fuse blowout is required.

The heat-generating resistor 14 is made of a conductive material, such as W, Mo and Ru, among others, which has a relatively high resistance and generates heat when a current flows therethrough. A powdered alloy, composition or compound of these materials is mixed with a resin binder to obtain a paste, which is screen-printed as a pattern on the insulating substrate 11 and baked to form the heat-generating resistor 14.

The insulating member 15 is arranged such that it covers the heat-generating resistor 14, and the heat-generating element extracting electrode 16 is disposed so as to face the heat-generating resistor 14 with the insulating member 15 interposing therebetween. The insulating member 15 may be laminated between the heat-generating resistor 14 and the insulating substrate 11 so as to efficiently conduct the heat of the heat-generating resistor 14 to the meltable conductor 13. The insulating member 15 may, for example, be made of a glass.

One end of the heat-generating element extracting electrode 16 is connected to a heat-generating element electrode 18 (P1). The other end of the heat-generating resistor 14 is connected to another heat-generating element electrode 18 (P2).

The meltable conductor 13 is made from a low melting point metal which can be blown out quickly by heat of the heat-generating resistor 14 and, for example, a Pb-free solder having Sn as a primary constituent is preferably used. Furthermore, the meltable conductor 13 may have a laminated structure of the low melting point metal and a high melting point metal of Ag, Cu or an alloy having one of these as a primary constituent.

By laminating a high melting point metal and a low melting point metal, when the protective element 10 is reflow mounted and the reflow temperature exceeds the melting point of the low melting point metal, even in the case of the low melting point metal melting, the meltable conductor 13 does not blow out. Such a meltable conductor 13 may be formed by plating techniques to film-form the low melting point metal onto the high melting point metal and may also be formed by using other known laminating and film-forming techniques.

It should be noted that the meltable conductor 13 is solder connected to the heat-generating element extracting electrode 16 and the electrodes 12 (A1), 12 (A2). The meltable conductor 13 can be easily connected by using reflow solder bonding. Additionally, in this regard, by a lower layer being a low melting point metal composed of Pb-free solder, this low melting point metal can be used to connect to the heat-generating element extracting electrode 16 and the electrodes 12 (A1), (A2).

It should be noted that, in the protective element 10, in order to protect internal portions thereof, a cover member, which is not illustrated in the drawings, can be provided on the insulating substrate 11.

### First Embodiment

In order to prevent oxidation of the meltable conductor 13 in the protective element 10, an oxide film removing agent 17 is provided on nearly the entire upper surface of the meltable conductor 13. A flux is preferably used as the oxide film removing agent. Hereinafter, the case in which flux is used as the oxide film removing agent 17 will be used for example in the description.

As illustrated in FIGS. 1 (A) and (B), a flux 20 according to the present invention includes a first flux layer 21 having a relatively low activation temperature and a second flux layer 22 having a relatively high activation temperature. The flux 20, by using a first and a second flux layer 21, 22 having different activation temperatures, has an activation temperature range of both an activation temperature range of the first flux layer 21 and an activation temperature range of the second flux layer 22 in combination.

Flux activation is a state in which the flux exhibits functionality for removing oxide film from the meltable conductor 13 and activation temperature is a temperature at which the solid flux is melted by heat and exhibits functionality for removing oxide film from the meltable conductor 13. Then, when the flux is heated beyond a given activation temperature thereof, the oxide film removing functionality is deactivated. An activation temperature range is defined as the temperature range in which the flux is activated.

The first and the second flux layers 21, 22 have an activation temperature determined by adding an activation agent to a rosin base. Examples of usable activation agents include organic acids such as palmitic acid (melting point 63° C.), stearic acid (melting point 70° C.), arachidic acid (melting point 76° C.), behenic acid (melting point 80° C.), malonic acid (melting point 135° C.), glutaric acid (melting point 97.5° C.), pimelic acid (melting point 106° C.), azelaic acid (melting point 106° C.), sebacic acid (melting point 134° C.) and maleic acid (melting point 130° C.) or amine salts of hydrobromic acid.

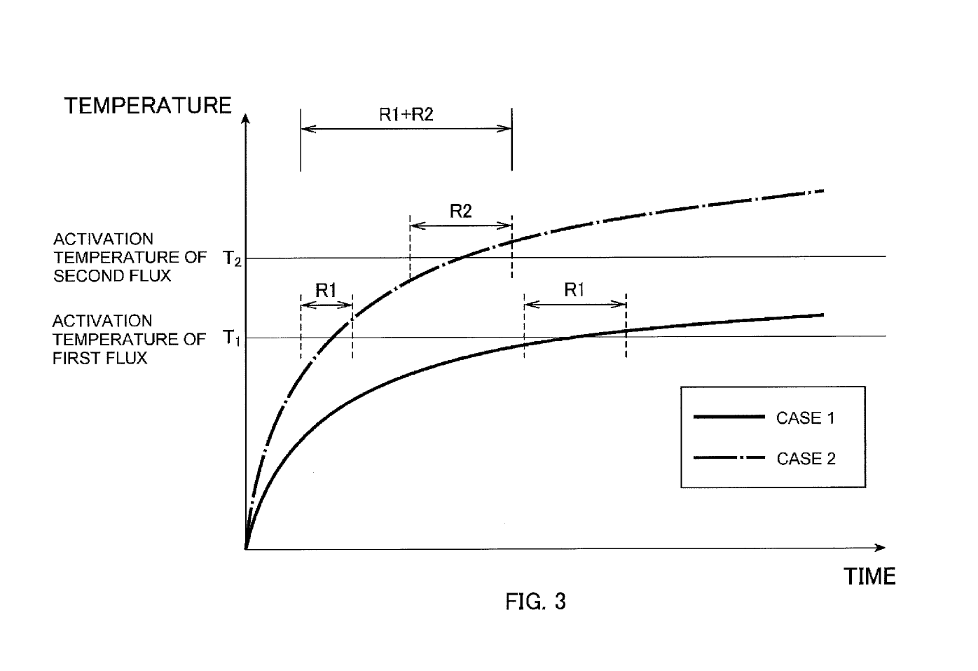

As illustrated in FIG. 3, by combining an activation temperature range R1 of the first flux layer 21 and an activation temperature range R2 of the second flux layer 22, the flux 20 has a combined activation temperature range (R1+R2) which can, even in the case of heat of the heat-generating resistor 14 causing a rapid increase in temperature, prevent oxidation of the meltable conductor 13 over a wide temperature range. Therefore, in the protective element 10, even in the case of rapid heating, oxidation of the meltable conductor 13 can be prevented and the current path can be quickly interrupted. Thus, while heating occurs rapidly, the flux 20 can be made to exhibit oxide film removing functionality, and the synergistic effect of these can improve the rapid blowout property of the protective element 10.

The multiple activation temperatures of the flux 20 may be any temperatures lower than the heating temperature of the heat-generating resistor 14 and, as shown in FIG. 3, in view of the temperature profile due to heating by the heat-generating resistor 14, the first flux layer 21 having an activation temperature T1 in a lower temperature range and the second flux layer 22 having an activation temperature T2 in a higher temperature range are preferably combined. By combining the activation temperatures R1, R2 of each flux layer 21, 22, the flux 20 has a combined activation temperature range (R1+R2) which covers an extended period of time; therefore, the flux 20 can remove oxide film from the meltable conductor 13 for an extended period of time while the heat-generating resistor 14 is heating.

Therefore, with the flux 20, in a Case 1, the temperature profile caused by heat of the heat-generating resistor 14 is gently sloping and activation of the first flux layer 21 removes oxide film from the meltable conductor 13, and in a Case 2, the temperature profile caused by heat of the heat-generating resistor 14 rises rapidly and, by activation of the second flux layer 22 following activation of the first flux layer 21, oxide film of the meltable conductor 13 can be removed over an extended period of time and rapid blowout can be achieved.

With this, the protective element 10 can be made compatible with a variety of temperature profiles and is not dependent on the type of electronic appliance or changes in the electrical output status thereof so that oxidation of the meltable conductor 13 can be prevented and the current path can be reliably interrupted. Contrastingly, in the case of using only one oxide film removing agent (flux), the activation temperature and the activation temperature range are limited and cannot be made compatible with all temperature profiles, particularly, the activation temperature range in the Case 2 is short and oxide film removing functionality cannot be made to be sufficiently exhibited.

It should be noted that the activation temperatures T1, T2 of each of the flux layers 21, 22 may be higher or lower than the melting point of the meltable conductor 13; furthermore, the activation temperature T1 of the first flux layer 21 and the activation temperature T2 of the second flux layer 22 may be selected so that the melting point of the meltable conductor 13 is therebetween. In any of these cases, because the heating temperature of the heat-generating resistor 14 is higher than the activation temperatures T1, T2 of each of the flux layers 21, 22 and the melting point of the meltable conductor 13, both oxidation of the meltable conductor 13 and oxide film removing effects of each of the flux layers 21, 22 activation are accomplished.

It should be noted that, as the flux 20, the oxide film removing agent 17, in addition to having the two flux layers 21, 22 having relatively different activation temperatures, may have three or more flux layers having relatively different activation temperatures.

In the flux 20, the flux layers are preferably laminated on the meltable conductor 13 in the order starting with the flux having the lowest activation temperature. For example, in the flux 20, as illustrated in FIG. 1, the first flux layer 21 having a relatively low activation temperature is laminated onto the meltable conductor 13 and the second flux layer 22 having a relatively high activation temperature is laminated onto the first flux layer 21. The first flux layer 21 having a relatively low activation temperature is thus positioned closer to the heat-generating resistor 14, which is the source of heat, by which the first flux layer 21 can be activated quickly after heating of the meltable conductor 13 begins. Furthermore, by laminating the first flux layer 21, which is activated quickly after heating begins, onto the meltable conductor 13, oxide film generated on the meltable conductor 13 soon after heating begins can be efficiently removed and blowout can be promoted. Then, when the heating temperature rises, the second flux layer 22 having a relatively high activation temperature is activated and removes oxide film formed on the conductor 13. Thus, in the protective element 10, when heating by the heat-generating resistor 14 begins, flux layer activation can be made to start in order from the flux layer having the low activation temperature.

Such a flux 20, in which multiple flux layers having different activation temperatures have been laminated, can be easily formed by, for example, after forming the meltable conductor 13 on the insulating substrate 11, printing the resin constituting the first flux layer 21 and drying to form the first flux layer 21, and then printing the resin constituting the second flux layer 22 and drying to form the second flux layer 22. Furthermore, three or more flux layers can also be formed by repeating this process.

Method of Using the Protective Element

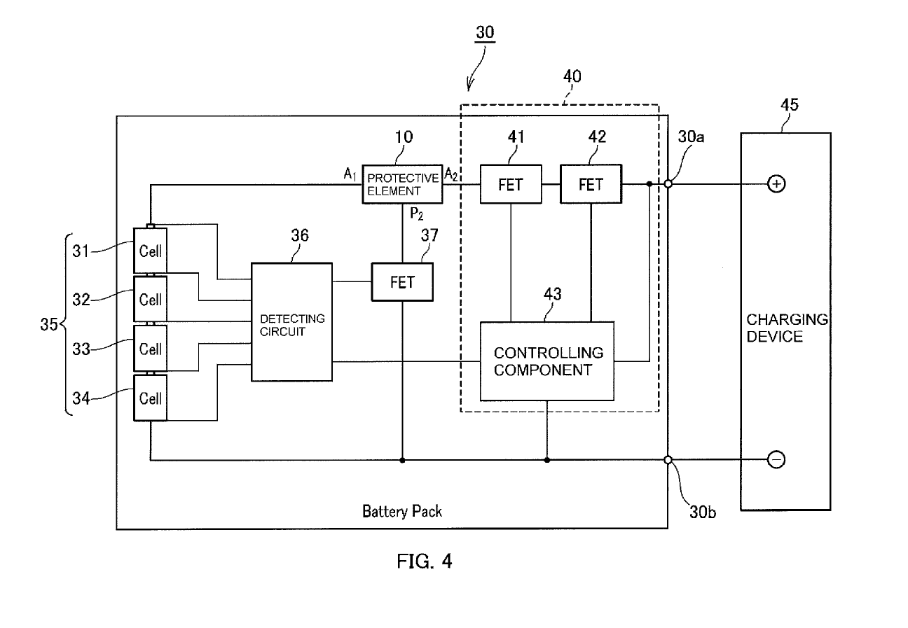

Such a protective element 10 can be used by incorporation into a circuit within a battery pack 30 of a lithium-ion secondary battery, as illustrated in FIG. 4, for example. The battery pack 30 has, for example, a battery stack 35 comprising a total of four battery cells 31 to 34 of a lithium ion secondary battery.

The battery pack 30 includes a battery stack 35, a charging/discharging controlling circuit 40 for controlling charging/discharging of the battery stack 35, a protective element 10 according to the present invention for interrupting charging when an abnormality is detected in the battery stack 35, a detecting circuit 36 for detecting a voltage of each battery cell 31 to 34, and a current controlling element 37 for controlling the operation of the protective element 10 in accordance with the detection result of the detecting circuit 36.

The battery stack 35, comprising the battery cells 31 to 34 connected in series and requiring a control for protection from an over-charging or over-discharging state, is removably connected to a charging device 45 via an anode terminal 30a and a cathode terminal 30b of the battery pack 30, and the charging device 45 applies charging voltage to the battery stack 35. The battery pack 30 charged by the charging device 45 can be connected to a battery-driven electronic appliance via the anode terminal 30a and the cathode terminal 30b and supply electric power to the electronic appliance.

The charging/discharging controlling circuit 40 includes two current controlling elements 41, 42 connected in series in the current path from the battery stack 35 to the charging device 45, and a controlling component 43 for controlling the operation of these current controlling elements 41, 42. The current controlling elements 41, 42 are formed of a field effect transistor (hereinafter referred to as FET) and the controlling component 43 controls the gate voltage to switch the current path of the battery stack 35 between a conducting state and an interrupted state. The controlling component 43 is powered by the charging device 45 and, in accordance with a detection signal from the detecting circuit 36, controls the operation of the current controlling elements 41, 42 to interrupt the current path when over-discharging or over-charging occurs in the battery stack 35.

The protective element 10 is connected in a charging/discharging current path between the battery stack 35 and the charging/discharging controlling circuit 40, for example, and the operation thereof is controlled by the current controlling element 37.

The detecting circuit 36 is connected to each battery cell 31 to 34 to detect voltage value of each battery cell 31 to 34 and supplies the detected voltage value to a controlling component 43 of the charging/discharging controlling circuit 40. Furthermore, when an over-charging voltage or over-discharging voltage is detected in one of the battery cells 31 to 34, the detecting circuit 36 outputs a control signal for controlling the current controlling element 37.

When the detection signal output from the detecting circuit 36 indicates a voltage exceeding the predetermined threshold value corresponding to over-discharging or over-charging of the battery cells 31 to 34, the current controlling element 37, which, for example, is formed of an FET, activates the protective element 10 to interrupt the charging/discharging current path of the battery stack 35 without the switching operation of the current controlling element 41, 42.

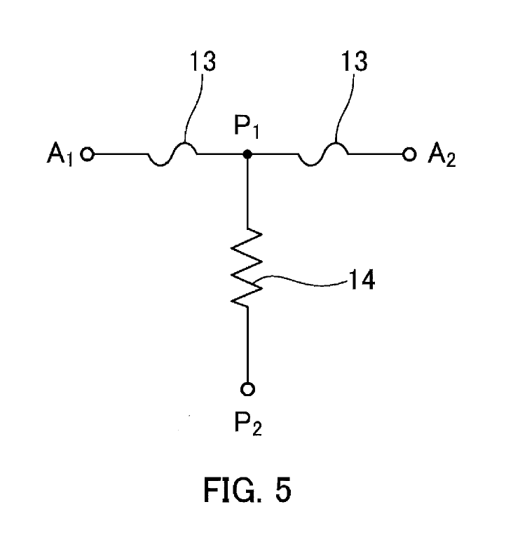

In the battery pack 30 having the structure described above, the protective element 10 according to the present invention has a circuit composition such as that illustrated in FIG. 5. Thus, the protective element 10 has a circuit composition comprising the meltable conductor 13 connected in series via the heat-generating element extracting electrode 16 and the heat-generating resistor 14 which melts the meltable conductor 13 by generating heat by a current flowing via the connection point thereof to the meltable conductor 13. Additionally, in the protective element 10, the meltable conductor 13 is connected in series on the charging/discharging current path and the heat-generating resistor 14 is connected to the current controlling element 37. Among the two electrodes 12 of the protective element 10, one is connected to A1 and the other is connected to A2. Furthermore, the heat-generating element extracting electrode 16 and the heat-generating element electrode 18 connected thereto are connected to P1 and the other heat-generating element electrode 18 is connected to P2.

The protective element 10 having such a circuit structure can reliably interrupt the current path by blowing out the meltable conductor 13 with heat generated by the heat-generating resistor 14.

Those skilled in the art will appreciate that the protective element according to the present invention is not limited to usage in battery packs of lithium ion secondary batteries but may be applied to any other application requiring interruption of a current path by an electric signal.

### Second Embodiment

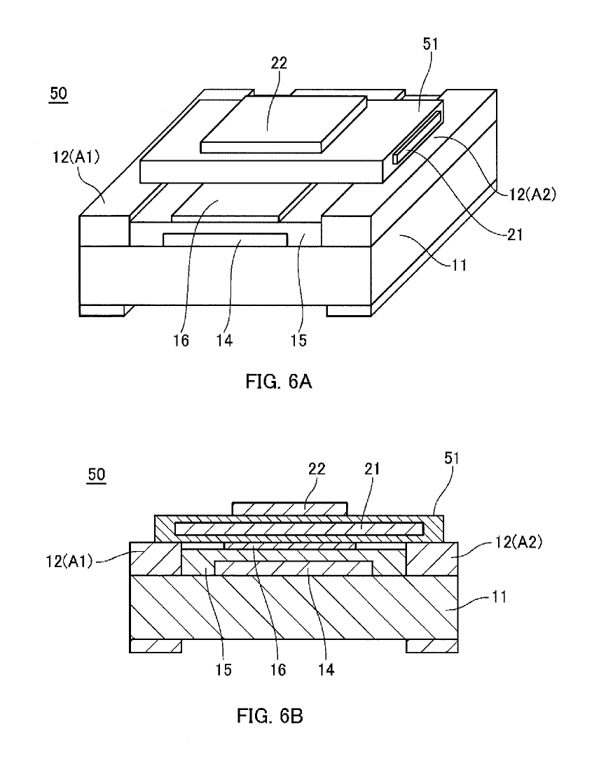

Next, another embodiment of the protective element according to the present invention will be explained. It should be noted that reference numerals of the protective element 10 described above are used in the following explanation where members are the same and details thereof have been abbreviated. In a protective element 50 illustrated in FIGS. 6 (A) and (B), a first flux layer 21 having a relatively low activation temperature is filled into a meltable conductor 51 and a second flux layer 22 having a relatively high activation temperature is laminated on the meltable conductor 51.

The meltable conductor 51 can be formed of the same material as used in the meltable conductor 13 explained above. Furthermore, as in the above-mentioned protective element 10, the protective element 50 has an insulating layer 11, an electrode 12, a heat-generating resistor 14, an insulating member 15, and heat-generating element electrodes 18.

In the protective element 50, because the first flux layer 21 is filled into the meltable conductor 51, contact surface area of the first flux layer to the meltable conductor 51 is large and oxide film generated on the meltable conductor 51 by heating of the heat-generating resistor 14 can thus be efficiently removed.

Furthermore, in the protective element 50, because the first flux layer 21 is filled into the meltable conductor 51, the first flux layer 21 is not exposed to air and deterioration thereof can be prevented for an extended period of time.

Still further, in the protective element 50, because the first flux layer 21 having a relatively low activation temperature is positioned closer than the second flux layer 22, which has a relatively high activation temperature, to the heat-generating resistor 14, which is the source of heat, when heating by the heat-generating resistor 14 begins, the first flux layer 21 is activated first, and when the temperature further rises, the second flux layer 22 is activated. Thus, in the protective element 50, when heating by the heat-generating resistor 14 begins, flux layer activation can be made to proceed in order starting from the flux layer having a lower activation temperature.

### Third Embodiment

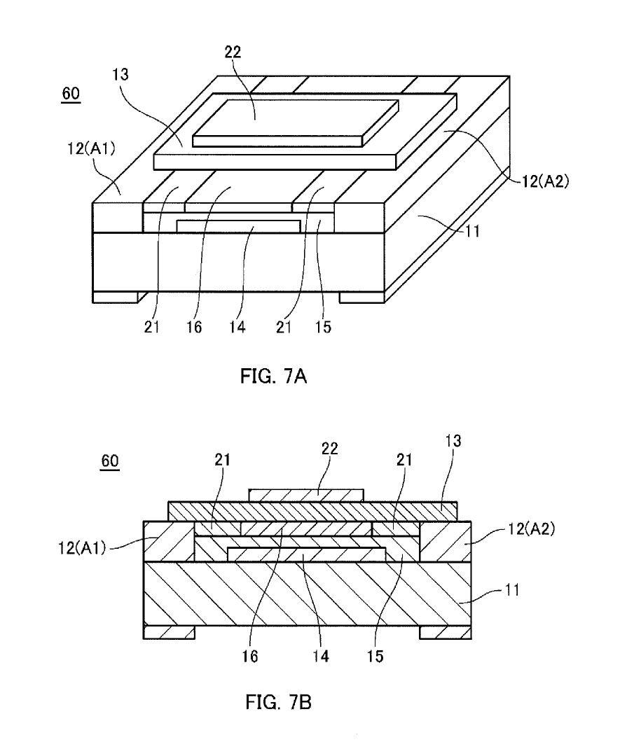

FIG. 7 illustrates another embodiment of the protective element according to the present invention. A protective element 60 illustrated in FIG. 7 has a first flux layer 21 formed between an electrode 12 (A1) and a heat-generating element extracting electrode 16 and between an electrode 12 (A2) and the heat-generating element extracting electrode 16 and a second flux layer 22 laminated on a meltable conductor 13. It should be noted that the protective element 60 has, as in the protective element 10 described above, an insulating substrate 11, electrodes 12, a heat-generating resistor 14, an insulating member 15 and heat-generating element electrodes 18.

In the protective element 60, because the first flux layer 21 having a relatively low activation temperature is positioned closer than the second flux layer 22, which has a relatively high activation temperature, to the heat-generating resistor 14, which is the source of heat, when heating by the heat-generating resistor 14 begins, the first flux layer 21 is activated first, and when the temperature further rises, the second flux layer 22 is activated. Thus, in the protective element 60, when heating by the heat-generating resistor 14 begins, flux layer activation can be made to proceed in order starting from the flux layer having a lower activation temperature.

The protective element 60 can be formed as described below. First, the electrodes 12 (A1) and (A2) and the heat-generating element extracting electrode 16 are formed above the insulating substrate 11. Next, a resin compound constituting the first flux layer 21 is applied by printing between the electrode 12 (A1) and the heat-generating element extracting electrode 16, and between the electrode 12 (A2) and the heat-generating element extracting electrode 16 and then drying. The meltable conductor is then formed such that it crosses above the electrodes 12 (A1) and (A2), the heat-generating element extracting electrode 16 and the first flux layer 21. A resin compound constituting the second flux layer 22 is finally applied on the meltable conductor 13 by methods such as printing and dried.

### Fourth Embodiment

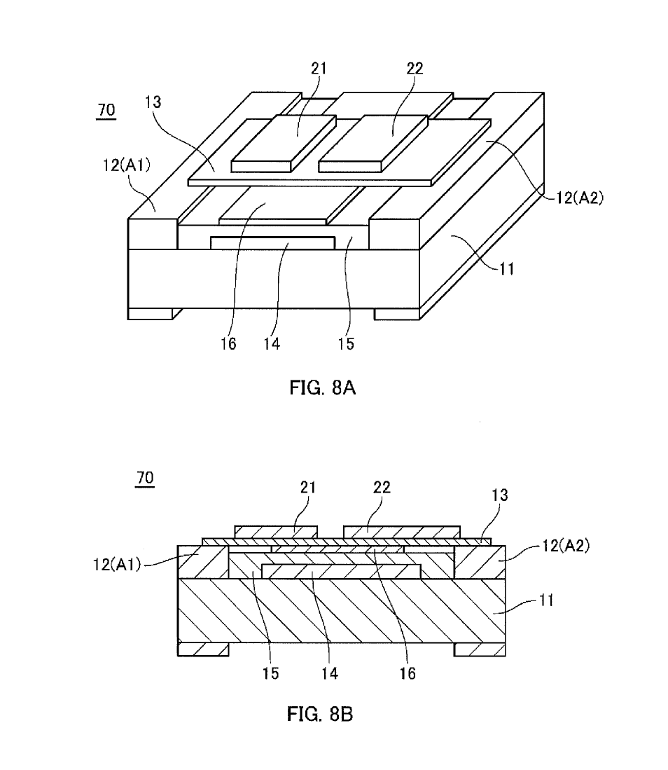

FIG. 8 illustrates another embodiment of the protective element according to the present invention. A protective element 70 illustrated in FIG. 8 has a first and a second flux layer 21, 22 adjacently laminated on a meltable conductor 13. The first flux layer 21 is laminated over an area between an electrode 12 (A1) and a heat-generating element extracting electrode 16 on a side of the meltable conductor 13 nearer to the electrode 12 (A1). Furthermore, the second flux layer 22 is laminated over an area between an electrode 12 (A2) and the heat-generating element extracting electrode 16 on a side of the meltable conductor 13 nearer to the electrode 12 (A2). It should be noted that the protective element 70 has, as in the protective element 10 described above, an insulating substrate 11, electrodes 12, a heat-generating resistor 14, an insulating member 15, and heat-generating element electrodes 18.

A blowout location on the meltable conductor 13 can be controlled in the protective element 70. In this regard, in the protective element 70, when heating by the heat-generating resistor 14 begins, the first flux layer 21 having a lower activation temperature is activated first and removes oxide film and promotes blowout on the electrode 12 (A1) side. Next, when the temperature rises further, the second flux layer 22 having a high activation temperature is activated and removes oxide film and promotes blowout on the electrode 12 (A2) side.

Even if the heat-generating resistor 14 heats the protective element 70 rapidly, and even if the first flux layer 21 is deactivated before blowout of the meltable conductor 13, the second flux layer is activated, and because oxidation of the meltable conductor 13 can be prevented and blowout can be promoted, the current path can be reliably interrupted between the electrode 12 (A2) and the heat-generating element extracting electrode 16.

### Example

An example of the present invention will now be explained. In this examination, a first flux layer having a relatively low activation temperature was laminated onto a meltable conductor and a second flux layer having a relatively high activation temperature was laminated onto this first flux layer to manufacture a protective element sample (example), and a flux layer comprising only one layer was laminated onto a meltable conductor to manufacture a conventional protective element sample (comparative example); eight of each of these were prepared and a predetermined electrical power was applied to a heat-generating resistor 14 and time until blowout was measured.

In the example, the first flux layer included palmitic acid (melting point 63° C.) added as an activation agent to a rosin base and, the second flux layer included azelaic acid (melting point 106° C.) added as an activation agent to a rosin base. Contrastingly, the flux layer in the comparative example included azelaic acid (melting point 106° C.) added as an activation agent to a rosin base.

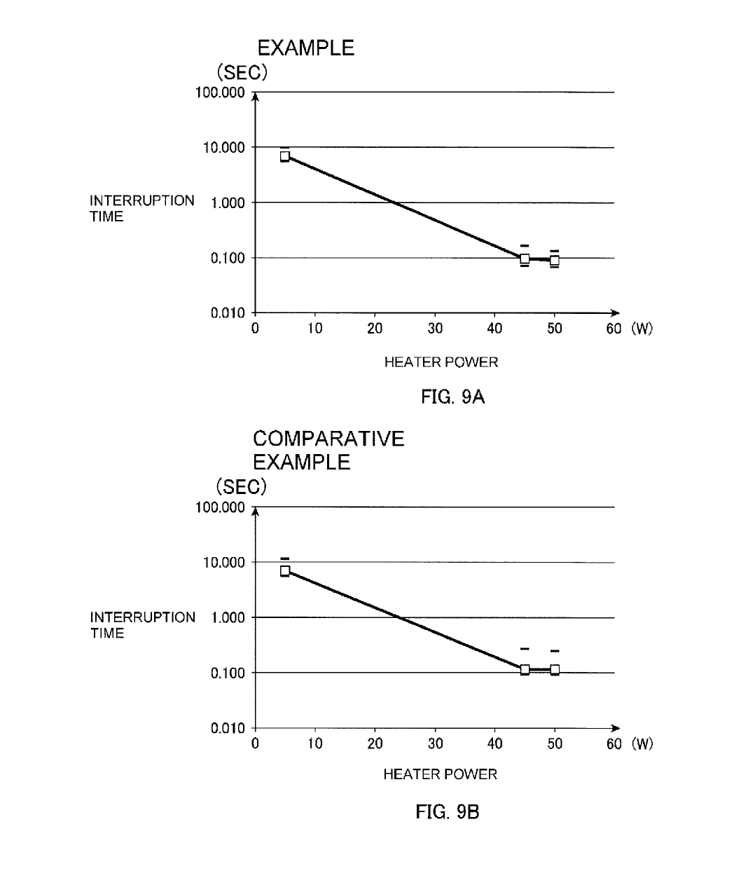

Additionally, 5 W, 45 W and 50 W of powers were applied to the heat-generating resistor of the protective element samples of the example and the comparative example. The results are shown in Table 1. Additionally, FIG. 9 (A) is a graph illustrating a relationship between applied power (W) and blowout time (seconds) of the protective elements of the example and FIG. 9 (B) is a graph showing a relationship between applied power (W) and blowout time (seconds) of the comparative example.

TABLE 1

| | | | |
|---|---|---|---|
| Applied power (W) | 5 | 45 | 50 |

Example

| | | | | |
|---|---|---|---|---|
| Blowout time | Maximum | 10.1 | 0.17 | 0.13 |
| (sec) | Minimum | 5.7 | 0.07 | 0.07 |
| | Average | 7.0 | 0.1 | 0.09 |
| | Variance | 4.4 | 0.1 | 0.07 |

Comparative example

| | | | | |
|---|---|---|---|---|
| Blowout time | Maximum | 11.5 | 0.28 | 0.25 |
| (sec) | Minimum | 5.6 | 0.08 | 0.07 |
| | Average | 7.4 | 0.12 | 0.12 |
| | Variance | 5.9 | 0.2 | 0.17 |

As shown in Table 1 and FIGS. 9 (A) and (B), blowout times in the example were shorter compared to those of the comparative example for all of the cases of 5 W, 45 W and 50 W applied to the heat generating resistor 14 and variance was also less in comparison. This occurred because larger powers correspond to faster rising temperatures and, in the protective elements of the comparative example, the flux activation temperature range was short and functionality for removing oxide film from the meltable conductor was not sufficiently exhibited.

Contrastingly, because the protective elements of the example had the second flux layer having a high activation temperature, even in the cases of a large power and quickly rising temperature, oxide could be removed from the meltable conductor even in high temperature ranges and rapid blowout could be achieved.

### REFERENCE SIGNS LIST

10 protective element, 11 insulating substrate, 12 electrodes, 13 meltable conductor, 14 heat-generating resistor, 15 insulating member, 16 heat-generating element extracting electrode, 17 oxide film removing agent, 18 heat-generating element electrodes, 19 cover, 20 flux, 21 first flux layer, 22 second flux layer, 30 battery pack, 31 to 34 battery cells, 35 battery stack, 36 detecting circuit, 37 current controlling element, 40 charging/discharging controlling circuit, 41, 42 current controlling element, 43 controlling component, 45 charging device, 50 protective element, 51 meltable conductor, 60 protective element, 70 protective element

1. A protective element comprising:
an insulating substrate;
a heat-generating element laminated onto the insulating substrate;
an insulating member laminated onto the insulating substrate covering at least the heat-generating element;
a first and a second electrode laminated onto the insulating substrate having the insulating member laminated thereon;
a heat-generating element extracting electrode laminated on the insulating member overlapping the heat-generating element and electrically connected to the heat-generating element on a current path between the first and the second electrode;
a meltable conductor laminated between the heat-generating element extracting electrode and the first and the second electrode and which interrupts the current path between the first and the second electrode by melting due to heat; and
an oxide film removing material for removing an oxide film generated on the meltable conductor;
wherein the oxide film removing material has a plurality of different activation temperatures.

2. The protective element according to claim 1, wherein the oxide film removing material comprises a plurality of flux having different activation temperatures.

3. The protective element according to claim 2, wherein a first flux having a relatively low activation temperature is laminated onto the meltable conductor and a second flux having a relatively high activation temperature is laminated onto the first flux.

4. The protective element according to claim 2, wherein a first flux having a relatively low activation temperature is filled into the meltable conductor and a second flux having a relatively high activation temperature is laminated onto the meltable conductor.

5. The protective element according to claim 2, wherein a first flux having a relatively low activation temperature is provided between the meltable conductor and the insulating substrate and a second flux having a relatively high activation temperature is laminated onto the meltable conductor.

6. The protective element according to claim 2, wherein a first flux having a relatively low activation temperature and a second flux having a relatively high activation temperature are adjacently laminated on the meltable conductor.

7. The protective element according to claim 2, wherein the plurality of flux have activation temperatures which are lower than a heating temperature of the heat-generating element.
